(19) United States
(12) Patent Application Publication
(10) Pub. No.: US 2010/0031626 A1
(43) Pub. Date: Feb. 11, 2010

(54) Carbon-Kevlar uni-body rocket engine and method of making same

(76) Inventor: Robert Oehrlein, Fairfax Station, VA (US)

Correspondence Address: Dennis H. Lambert, Esq., 7000 View Park Drive, Burke, VA, 22015, US

(21) Appl. No.: 12/218,372

(22) Filed: Jul. 15, 2008

Related U.S. Application Data
(63) Continuation-in-part of application No. 12/077,758, filed on Mar. 21, 2008.

(51) Int. Cl. F02K 9/00; B32B 37/10

(52) U.S. Cl. 60/200.1; 156/163

(57) ABSTRACT

A rocket engine has spaced apart inner and outer skins each unitarily formed in one piece from carbon fiber fabric. The inner skin is formed on a two-part mold that is separated and removed from the inner skin after it is cured. An oxidizer ring encircles the bottom of the engine and is in flow communication with flow channels between the skins. Oxidizer tubes are connected at one end to the ring and at their other end to support brackets on the engine. The oxidizer ring is formed as an integral part of the engine by extending the outer skin over an inflatable mold, which is deflated and removed from the ring after the ring is cured. The oxidizer tube is formed on a mold with a rigid spine that holds the shape of the mold until the oxidizer tube is cured. The spine and the mold are then removed.

This application is a continuation-in-part of U.S. application Ser. No. 12/077,758, filed Mar. 21, 2008, the entire disclosure of which is incorporated herein by reference.

### TECHNICAL FIELD

This invention relates generally to rocket engines, and more particularly to a reinforced, regeneratively cooled, carbon-Kevlar uni-body rocket engine with a redundant soft-start ignition, and to the method of making the same.

### BACKGROUND ART

Conventional rockets take off vertically and use a propellant that is a chemical mixture of fuel and oxidizer burned to produce thrust. The single heaviest item carried by a spaceship is the propellant, of which the oxidizer comprises the majority.

The greatest rate of oxygen consumption for a rocket engine is relatively close to the ground, where atmospheric air up to about 40,000 feet contains a relatively large amount of oxygen. In spite of the presence of oxygen at low altitudes, conventional space ships, regardless of the type of propellant they burn, carry the required oxygen on-board, adding significantly to the mass of the spaceship.

To ignite the fuel and oxidizer mixture of a typical rocket engine, including the engines of the space shuttle, a shower of sparks is directed at the base of the engine into the explosive mixture of fuel and oxidizer being emitted from the engine. Prior to ignition, this explosive mixture fills the combustion chamber, the throat, the exhaust bell, and the space between the bell and the ground. When the shower of sparks touches the fuel-oxidizer mixture, there is a sudden all-over ignition. This is called a hard start and is dangerous and stressful on the equipment.

Further, conventional space ships do not provide any means for propulsion upon return to earth, when all the fuel is used up. For example, upon its return to earth the space shuttle functions essentially as a glider that must make a successful landing on the first pass.

Conventional rocket engines typically are made of metal, with multiple pieces welded together to form the combustion chamber, throat, and exhaust nozzle or bell, leading to manufacturing complexities and increased cost, with potential failure points.

One known example of a regeneratively cooled rocket engine currently under development is made of welded-together pieces of metal, forming a combustion chamber, throat, and exhaust bell with spaced apart inner and outer skins. Oxidizer is supplied through an oxidizer tube to an oxidizer ring at the bottom end of the exhaust bell and then upwardly between the skins to the upper end of the combustion chamber. Only a single tube is provided, attached perpendicularly to the ring, and attached to the engine only at the ring. The oxidizer tube and oxidizer ring in the foregoing conventional construction are formed of metal and are made as separate pieces that are welded to the engine body.

It would be advantageous to have a rocket engine of uni-body design to eliminate potential points of weakness resulting from welded together pieces of metal as in conventional rocket engines. In particular, it would be desirable to have a uni-body rocket engine made of a composite material, preferably a carbon fiber fabric, or Kevlar, or Kevlar-reinforced carbon fiber fabric.

It would also be advantageous to have a rocket engine in which the engine body, oxidizer ring, oxidizer tubes, and brackets connecting the tubes to the engine above the throat of the engine are all unitarily and integrally formed from a composite material, preferably a carbon fiber fabric, or Kevlar, or Kevlar-reinforced carbon fiber.

It would be further advantageous in a Kevlar-reinforced uni-body construction to have spaced apart longitudinally extending ribs bonded to and between the skins to form channels for flow of the oxidizer, and that serve to reinforce the uni-body construction from one end of the engine to the other.

Further, it would be advantageous to have a regeneratively cooled rocket engine in which the oxidizer tubes are attached at one end thereof to the oxidizer ring at the bottom of the exhaust nozzle and at their other end to brackets extending from the combustion chamber above the throat, thereby further reinforcing the engine, especially across the throat, its narrowest and potentially weakest point.

It would further be advantageous to connect the lower end of the oxidizer tubes to the oxidizer ring in a generally tangential direction for improved flow, and to use multiple oxidizer tubes for more efficient and uniform distribution of the oxidizer in the flow channels between the skins of the uni-body and to enable supply of multiple types of oxidizer from different sources.

A further advantage would be to have an ignition system that directs a relatively small amount of fuel toward one or more igniters to initiate combustion, resulting in a “soft start”, rather than to completely fill the combustion chamber, throat and nozzle before igniting the fuel and oxidizer mixture as in conventional designs, a so-called “hard start”.

A still further advantage would be to have multiple igniters to provide a redundant ignition in the event of failure of one igniter.

It would be advantageous to have a rocket engine that uses outside air at altitudes up to about 40,000 feet, then blends on-board oxidizer with the outside air up to about 100,000 feet, and then uses stored oxidizer alone. This would eliminate the need for the two turbofan engines and their attendant weight currently proposed for use at lower altitudes in conventional space plane designs.

### SUMMARY OF THE INVENTION

The rocket engine according to the present invention is of one-piece, uni-body construction preferably made with a composite material, preferably a carbon fiber fabric, or Kevlar, or Kevlar-reinforced carbon fiber.

The engine of the invention preferably is regeneratively cooled and has one or more oxidizer tubes connected between an oxidizer ring at the bottom of the exhaust nozzle and a source of oxidizer. The tubes are integrally connected at one end to the oxidizer ring and at the other end are integrally connected to mounting brackets that are integrally connected to the combustion chamber in bridging relationship to the throat. In addition to supplying oxidizer to the oxidizer ring, the oxidizer tubes also reinforce the engine, especially across the throat, its narrowest and potentially weakest point.

In the engine of the invention the lower end of the oxidizer tube is connected to the oxidizer ring in a generally tangential direction for improved flow, and in preferred embodiments multiple oxidizer tubes are used for more efficient and uniform distribution of the oxidizer in the flow channels between the skins of the uni-body and to enable supply of multiple types of oxidizer from different sources. The engine uses outside air at altitudes up to about 40,000 feet, then blends on-board oxidizer with the outside air up to about 100,000 feet, and then uses on-board oxidizer alone, thus enabling use of a single type of engine operable at all altitudes, rather than requiring use of a first engine type that uses outside air at lower altitudes and a second engine type that uses on-board oxidizer at higher altitudes.

The rocket engine of the invention is of one-piece uni-body construction formed from a composite material, thereby eliminating potential points of weakness that can result from welded together pieces of metal as in conventional rocket engines. In particular, the rocket engine of the invention comprises an engine body having a combustion chamber, a throat, and an exhaust bell, with an oxidizer ring encircling the bottom end of the exhaust bell, and at least one oxidizer tube, preferably a plurality of tubes, connected at one end to the oxidizer ring and at their other end to mounting brackets extending radially outwardly from the combustion chamber.

The engine body, that is the combustion chamber, throat and exhaust bell, comprises spaced apart inner and outer skins integrally formed as one piece from a composite material, preferably a carbon fiber fabric, or Kevlar, or Kevlar-reinforced carbon fiber fabric, with spaced apart longitudinally extending ceramic ribs bonded to and between the skins to form channels for flow of the oxidizer and to reinforce the uni-body construction from one end of the engine to the other.

The oxidizer ring is toroidally shaped and is formed integrally with and as a continuation of the outer skin and communicates with the oxidizer flow channels extending upwardly between the skins. The oxidizer tubes are integrally connected at their lower end substantially tangentially to the oxidizer ring and extend longitudinally of the engine to above the throat of the engine. The upper ends of the oxidizer tubes are integrally connected to radially outwardly extending mounting brackets that are integrally connected to the combustion chamber of the engine.

The inner and outer skins are brought together and turned outwardly at their upper ends to form a radially outwardly directed annular flange for mounting a fuel plate assembly to the engine, and the lower end of the inner skin is turned outwardly to form a radially outwardly directed annular flange against which the oxidizer ring is positioned. The lower end of the outer skin is shaped to form at least a substantial portion of the oxidizer ring.

To make the one-piece engine body of the invention, i.e., the combustion chamber, throat and exhaust bell, at least one layer, and preferably multiple layers, of a composite material such as carbon fiber fabric are wrapped around a mold and bonded with a phenolic resin to form the inner skin of the engine. The mold is constructed, and the fabric laid up, so that the inner skin has annular flanges at its top and bottom ends, i.e., an outwardly directed flange at the top end of the combustion chamber, and an outwardly directed flange at the bottom end of the exhaust bell. The mold preferably is in two parts, normally called plugs, which separate at the throat of the engine so that the mold parts can be pulled out of the formed inner skin after it is cured.

A plurality of longitudinally extending spaced apart ribs, preferably a ceramic fiber braid square in cross-section, is bonded to the outer surface of the inner skin with a high temperature adhesive. Some of the ribs extend substantially the full length of the engine body from the top flange to the bottom flange, but approximately half extend only over the length of the exhaust bell and terminate at their upper ends short of the throat. For a reason described hereinafter, all of the ribs are spaced a short distance upwardly from the bottom flange formed on the bottom end of the engine. In a specific example this distance is approximately two inches.

The oxidizer ring is formed by applying an inflatable, toroidally shaped mold around the lower end of the exhaust bell, with the radially inner side of the mold lying between the lower ends of the ribs and the spaced bottom flange and engaged against the outer surface of the inner skin at its bottom end. One or more layers, preferably a plurality of layers, of a composite material such as carbon fiber fabric, Kevlar, or Kevlar-reinforced carbon fiber, are wrapped around the outside of the ribs and around the toroidally shaped mold and bonded with resin. After curing, one or more openings is cut into the radially outer side of the oxidizer ring and the inflatable mold is deflated and removed through one or more of the openings, forming a toroidally shaped oxidizer ring that is integral with the exhaust bell at its bottom end. The structure is then heated to further cure the resin. Because of the way the carbon fiber fabric is laid up when forming the outer skin, the entire radially inner side of the toroidal oxidizer ring is open to the spaces between the ribs when the inflatable mold is removed.

A reinforcing layer of Kevlar/Carbon Hybrid fabric is then bonded to the outer surface of the outer skin, it being understood that the term “layer” is intended to cover multiple plies of Kevlar/Carbon Hybrid fabric.

The mounting brackets are made with a composite material, preferably a carbon fiber fabric, or Kevlar, or Kevlar-reinforced carbon fiber, and bonded at one end to the outside of the engine near the lower end of the combustion chamber so that the arms extend radially outwardly from the engine. The brackets are integrated into the structure of the engine with overlapping strips of composite material bonded with resin applied at and around the juncture between the brackets and engine. In a preferred construction the brackets have an inverted U-shape in transverse cross-section.

The oxidizer tubes are made in one piece on a generally L-shaped mold that comprises a firm but yieldable tubular body with a relatively rigid spine or core extending through it to maintain the body in the L-shape. One or more layers of composite material such as, for example, carbon fiber fabric or Kevlar-reinforced carbon fiber fabric bonded with resin are applied to the mold and cured. The spine, which is separable into two parts, each removable through a respective opposite end of the mold, is then pulled out of the mold, after which the yieldable body can be pulled out of the cured oxidizer tube through one end. The composite material may be in the form of a sock or sleeve that is slipped over the mold from one end, and/or in the form of strips of fabric that are wrapped around the mold.

The upper ends of the oxidizer tubes are bonded to the outer ends of the mounting brackets and the lower ends are mated with the openings cut in the oxidizer ring and bonded to the ring. The oxidizer tubes are integrated into the structure of the support brackets and the oxidizer tube by bonding overlapping strips of the composite material around the connections between the tubes, brackets and ring.

The fuel plate assembly of the invention can be designed so that the fuel plate manifold is oriented downwardly and extends into the upper end of the combustion chamber, enabling the oxidizer to flow into the manifold from the sides, as shown and described in parent application Ser. No. 12/077,758, or it can be designed as shown herein so that the manifold projects upwardly from the combustion chamber. As shown and described in the parent application, the plurality of holes in the fuel plate for supplying oxidizer and fuel to the combustion chamber can extend at an angle through the plate to produce a swirling or vortex action in the combustion chamber, or they can extend perpendicularly through the plate.

As in the parent application, individually controlled auxiliary fuel supply tubes can be connected with the fuel plate assembly, in addition to the main fuel supply, to supply more fuel to selected parts of the fuel plate manifold when desired for extra boost, and/or to supply different fuel or fuels.

As described in detail in the parent application, the engine of the invention preferably has an ignition system that directs a relatively small amount of fuel toward one or more igniters to initiate combustion, resulting in a “soft start” ignition system, rather than to completely fill the combustion chamber, throat and nozzle before igniting the fuel and oxidizer mixture as in conventional designs, a so-called “hard start” ignition system. Additionally, the engine of the invention preferably has multiple igniters to provide a redundant ignition in the event of failure of one igniter.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top perspective view of a rocket engine according to the invention, with a fuel plate assembly in position on the combustion chamber.

FIG. 2 is a top perspective view of the one-piece, integrally formed rocket engine body according to the invention, with the fuel plate assembly removed.

FIG. 3 is a longitudinal sectional view of the combustion chamber, throat and exhaust bell of the engine body of FIG. 2, shown in a first stage of manufacture of the engine, wherein the inner skin is formed as one piece on a two-part mold, with the mold depicted in dot-and-dash lines in a first position for forming the inner skin around the mold, and in a second position being withdrawn from the cured inner skin.

FIG. 4 is a side view in elevation of the engine body of FIG. 3, shown in a further stage of manufacture wherein longitudinally extending ribs have been applied to the outer surface of the inner skin, and a toroidally shaped inflatable mold has been applied to the lower end of the exhaust bell for forming the oxidizer ring.

FIG. 5 is a side view of the engine of FIG. 4 in a further stage of manufacture, with the left hand portion of the drawing shown in longitudinal section and the right hand side shown in elevation, wherein the outer skin has been applied over the ribs and over the inflatable mold.

FIG. 6 is an enlarged fragmentary sectional view showing details of the circled portion indicated by the numeral 6 in the lower left hand corner of FIG. 5.

FIG. 7 is an enlarged fragmentary sectional view showing details of the circled portion indicated by the numeral 7 in the upper left hand corner of FIG. 5.

FIG. 8 is a fragmentary transverse sectional view taken along line 8-8 in FIG. 5.

FIG. 9 is an exploded, longitudinal sectional view of a mold for forming the oxidizer tubes used in the engine of the invention, showing a carbon fiber fabric or Kevlar sleeve in position to be placed over the mold.

FIG. 10 is a side view in elevation showing the mold being removed from a formed oxidizer tube.

### DETAILED DESCRIPTION OF THE PREFERRED EMBODIMENTS

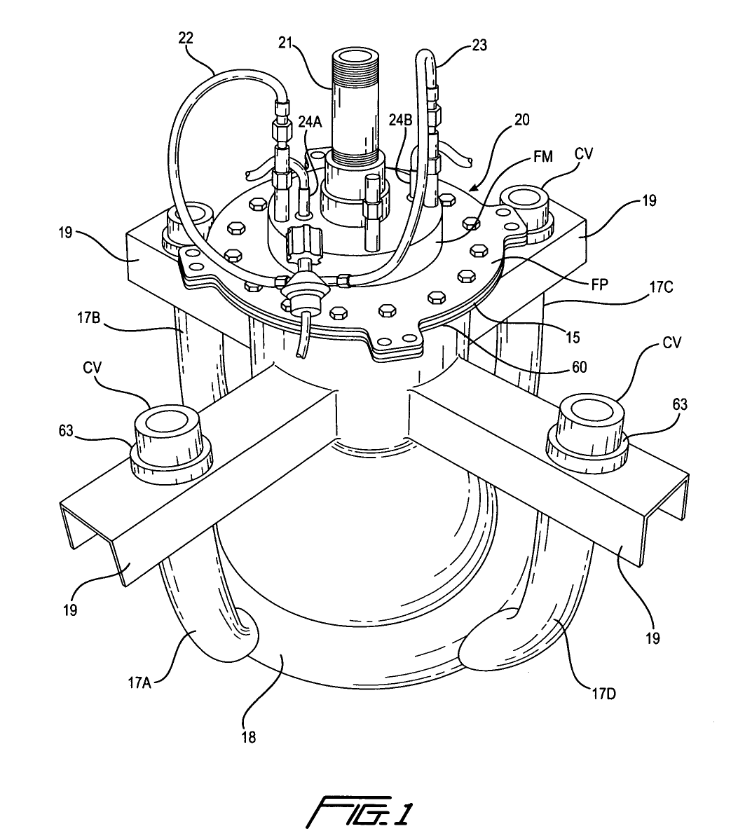

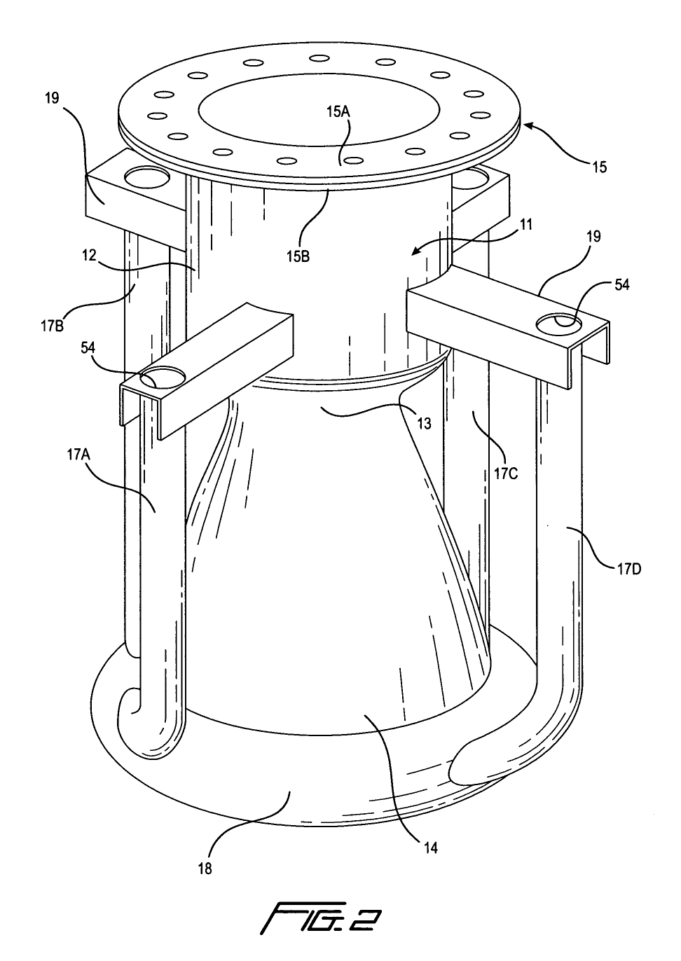

An integrally formed one-piece rocket engine according to the invention is indicated generally at 10 in FIGS. 1 and 2. The engine 10 comprises an engine body 11 having a combustion chamber 12 of substantially cylindrical shape, a reduced diameter throat 13, and an outwardly flared exhaust bell or nozzle 14, with a radially outwardly directed upper flange 15 on its upper end and a radially outwardly directed bottom flange 16 on its lower end. The engine body is of substantially conventional shape is but formed integrally as one piece. Four oxidizer tubes 17A, 17B, 17C and 17D are provided in this embodiment, extending longitudinally of the engine and connected tangentially at their lower ends to an oxidizer ring 18 formed integrally on the exhaust bell at its bottom end, and connected at their upper ends to mounting brackets 19 that are in turn integrally connected to the combustion chamber just above the throat. This arrangement not only permits supply of oxidizer to multiple points on the oxidizer ring, thereby obtaining more even distribution of the oxidizer around the ring and thence upwardly through the channels between the skins, as described more fully in the parent application, but also enables different oxidizers to be used, e.g. outside air and/or on-board oxidizer. This type of engine, i.e. with the oxidizer circulated through the skin of the engine, is referred to as regeneratively cooled.

As seen in FIG. 1a fuel plate assembly 20 is mounted to the upper flange 15 on the upper end of the combustion chamber for supplying fuel and oxidizer to the combustion chamber. The primary difference between the fuel plate assembly shown in FIG. 1 and that shown and described in the parent application is that the fuel manifold FM in the present embodiment extends above the fuel plate FP and externally of the combustion chamber, whereas the fuel manifold in the assembly disclosed in the parent application extends below the fuel plate and into the combustion chamber. Otherwise, the fuel metering orifices, igniters, fuel supply, check valves, and the like, are the same as in the parent embodiment. A main fuel supply 21 is connected to the center of the fuel manifold FM, and redundant ignition fuel supplies 22 and 23 are connected to the fuel manifold on opposite sides thereof. As described in the parent application, the ignition fuel is fed into the combustion chamber through angled orifices, and igniters 24A and 24B extend through the fuel plate assembly and into the combustion chamber for igniting the ignition fuel and oxidizer mixture, as explained more fully in applicant's copending parent application Ser. No. 12/077,758.

The oxidizer/coolant comes from tanks (not shown) of stored nitrous oxide or other suitable oxidizer, and/or from atmospheric air at lower altitudes, and in a preferred embodiment is supplied from the tanks through 2″ diameter pipes (not shown) and then enters the 3″ diameter oxidizer tubes 17A, 17B, 17C and 17D before entering the 4″ diameter oxidizer ring 18. Although specific dimensions are given for this progressively larger plumbing, it should be understood that other dimensions could be used, depending upon the requirements of the engine. The progressively larger plumbing on the way to the combustion chamber promotes expansion of the gas from its stored liquid form into a gaseous form, causing it to cool. Check valves CV may be provided in the oxidizer tubes to prevent reverse flow.

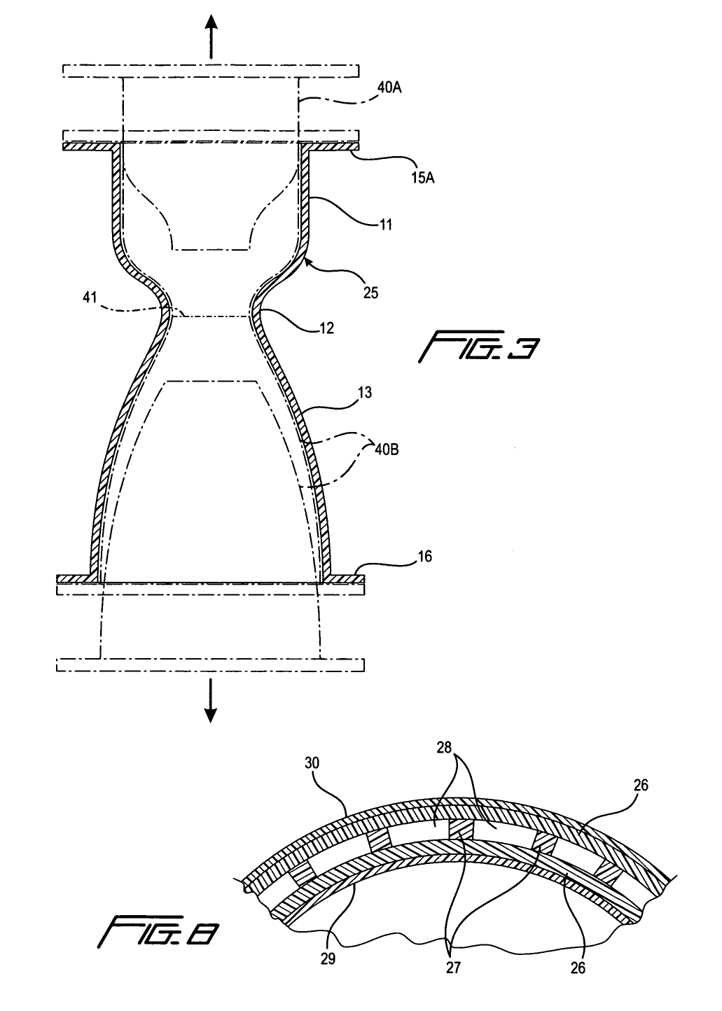

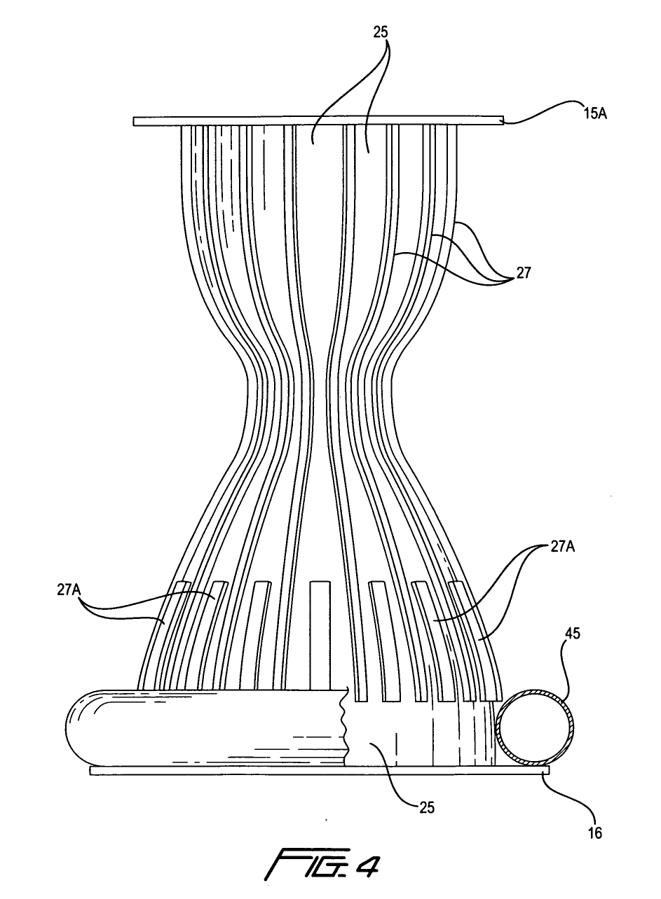

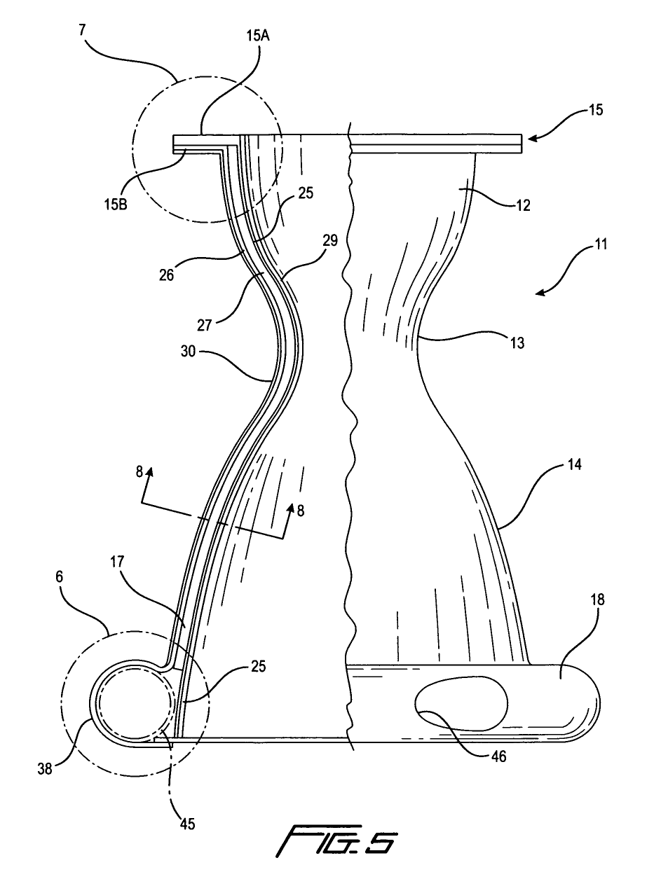

With particular reference to FIGS. 2-8, the integrally formed one-piece engine body 11 comprises an inner skin 25 and a spaced outer skin 26, both extending continuously throughout the length of the engine, with a plurality of spaced apart ribs 27 and 27A extending between and bonded to the skins. As seen best in FIG. 4, the ribs 27 extend substantially the full length of the engine body, but the ribs 27A extend only along the exhaust bell and terminate at their upper ends short of the throat. As seen best in FIG. 6, all of the ribs 27 and 27A terminate at their lower ends spaced a short distance upwardly from the bottom flange 16. The ribs reinforce the uni-body construction, and with the skins define a plurality of flow channels 28 (see FIG. 8) for flow of oxidizer from the oxidizer ring to the fuel plate assembly. As the oxidizer flows through the channels it has a cooling effect on the walls of the exhaust bell, throat and combustion chamber of the engine. In the particular example shown there are forty square ceramic rope ribs 27, 27A that give great strength vertically and provide even spacing between the skins top to bottom to make forty coolant channels 28. It should be noted that for purposes of illustration the scale of the flow channels and ribs is exaggerated in relation to the skins. In actuality, the skins are much thicker in relation to the flow channels and ribs than shown in the drawings.

In a preferred construction, both the inner and outer skins 25 and 26 are made of fiber reinforced composites, comprising plural layers of carbon fiber fabric bonded with a phenolic resin mixed with a hardener. Examples of suitable carbon fiber fabrics that may be used in the construction of the engine are part number FG-CF61150, a twill weave, and part number FG-CARB5750, a plain weave, both available from U.S. Composites in West Palm Beach, Fla. Other carbon fiber fabrics may be suitable, but the foregoing have been used successfully. An example of a suitable resin is Phenolic resin J2027L mixed with PhenCat 382 hardener from Capital Resin Corp. in Columbus Ohio, ordered through Mektech Composites in Hillsdale N.J. The ribs 27 comprise a ceramic fiber braid, square in cross-section, sold under part number IN001075 by Graphitestore.com. The ribs may be bonded to the skins with the same phenolic resin used to bond the layers of carbon fiber fabric together.

The inner surface of the inner skin preferably is coated with a layer 29 of high temperature resistant material, such as high temperature graphite, also sold by Graphitestore.com, under the name Graphi-Bond 551RN Graphite Adhesive (part number AR001810). Alternatively, the inner surface of the combustion chamber, throat and exhaust bell may be coated with Coltronics Graphite Adhesive 931, rated at 3000 degrees Celsius. This layer provides extra strength and helps protect the skins from the high temperatures in the combustion chamber, throat, and exhaust bell.

A reinforcing layer 30 of Kevlar/Carbon Hybrid fabric, sold by Fibre Glast Developments Corporation of Brookville, Ohio, under part number 1065 or 1066 or 1067, depending upon the color selected, is applied to the outer surface of the outer skin. It should be noted that the term “layer” is intended to cover multiple plies of Kevlar/Carbon Hybrid fabric.

FIG. 3 depicts a first step in making the one-piece integrated rocket engine construction of FIG. 2. As shown in FIG. 3, the inner skin 25 is formed on a two-part mold 40A, 40B that has a parting line 41 at approximately the middle of the throat of the engine, as depicted in dot-and-dash lines in FIG. 3. The upper and lower ends of the inner skin 25 are turned outwardly, defining radially outwardly extending flanges 15A and 16 at the top and bottom ends, respectively, of the inner skin. The carbon fiber fabric and resin are applied to the mold in the desired number of layers and then cured in a furnace. After the inner skin has been formed and cured, the two mold parts 40A and 40B are withdrawn through the respective opposite open ends of the formed inner skin.

As shown in FIG. 4, the ribs 27, 27A are then applied to the outer surface of the inner skin and bonded thereto with the resinous bonding agent. The ribs extend at their upper end to the flange 15A but at their lower end are spaced from the flange 16. A toroidally shaped inflatable mold 45 for forming the oxidizer ring 18 is placed around the outside of the lower end of the exhaust bell, lying between the lower ends of the ribs and the top surface of the bottom flange and against the outer surface of the lower end of the inner skin 25.

As shown in FIGS. 5, 6, 7 and 8, the outer skin 26 is then applied over and bonded to the ribs 27, 27A, with the upper end of the outer skin turned outwardly to form flange 15B that is bonded to the flange 15A on the upper end of the inner skin, forming the upper flange 15. The lower end 38 of the skin 26 is wrapped around the inflatable mold 45 and bonded to the bottom flange 16, forming the toroidally shaped oxidizer ring 18. After the outer skin has cured, openings 46 are cut in the oxidizer ring 18, and the inflatable mold 45 is deflated and removed through the openings 46. Further curing can then be accomplished in a furnace.

The oxidizer tube support brackets 19 are formed by layering the carbon fiber fabric and bonding agent on a suitably shaped mold (not shown) and curing it.

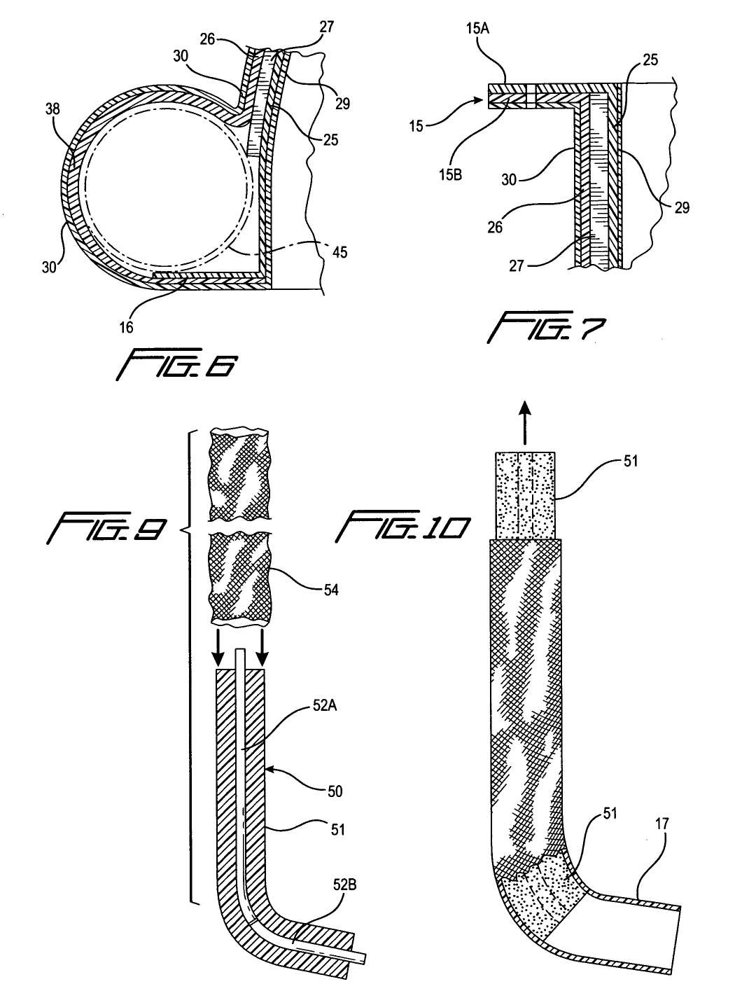

As depicted in FIGS. 9 and 10, the oxidizer tubes 17A, 17B, 17C and 17D are formed on a special mold 50 that comprises a yieldable but firm foam tube 51 held in the desired, generally L-shaped configuration by a two-piece rigid spine 52A, 52B inserted into the tube. Kevlar-reinforced carbon fiber fabric and a bonding agent are then applied to the outside of the mold 50 and cured. As depicted in FIG. 9, the fabric can be in the form of a sleeve or sock 54, or it can comprise separate strips or sheets. After the bonding agent has cured, the two parts 52A, 52B of the rigid spine are separated from one another and removed through respective opposite ends of the foam tube 51, as depicted in FIG. 10.

One end of the oxidizer tube support brackets 19 is then integrally molded to the engine by wrapping overlapped pieces of Kevlar-reinforced carbon fiber fabric around the juncture of the brackets with the engine body and around adjacent portions of the bracket and body.

After the attachment of the brackets to the body is cured, the oxidizer tubes 17A, 17B, 17C and 17D are positioned and aligned at their respective upper ends with holes 54 cut in the outer ends of the brackets 19 and at their lower ends with the openings 46 cut in the oxidizer ring 18. Kevlar-reinforced carbon fiber fabric is then wrapped around and bonded with the junctures of the oxidizer tubes, brackets, and oxidizer ring, and around adjacent portions of the tubes, brackets and ring. Following curing, the one-piece integral rocket engine body of FIG. 2 is produced.

As in the construction disclosed in the parent application, the fuel plate assembly 20 is affixed to the flange 15 on the upper end of the engine, with the composite material of the flange 15 sandwiched between the fuel plate FP that rests on top of the flange, and an annular mounting ring 60 positioned under the flange. These parts are fastened together by suitable means such as bolts 61 (see FIG. 1).

Check valve mounting rings 63 are bonded in the holes 54 in the outer end of the mounting brackets 19, one of which is shown on one of the brackets in the right hand portion of FIG. 2. These mounting rings are internally threaded for receipt of the check valves CV, shown in FIG. 1.

The use of auxiliary fuel supply in addition to the main fuel supply makes the engine a multi-fuel hybrid since it can use one fuel, e.g. propane, kerosene, or other fuel, in its main center fuel port and another fuel, e.g. propane, kerosene, or other fuel, in its turbo booster ports, as described more fully in the parent application.

Further, because of the use of multiple oxidizer tubes the engine of the invention is also a multi-oxidizer hybrid since it can use outside air, nitrous oxide, or liquid oxygen (LOX), or other suitable oxidizer, or a combination of these. In the embodiment shown in FIGS. 1 and 2, four oxidizer tubes are employed, but one, two, three, or some other number could be used as desired or necessary.

It will be noted that two igniters and associated ignition fuel ports are provided. This is a redundant system for safety, but only one igniter and associated ignition fuel supply port could be used if desired.

Although particular embodiments of the invention are illustrated and described in detail herein, it is to be understood that various changes and modifications may be made to the invention without departing from the spirit and intent of the invention as defined by the scope of the appended claims.

What is claimed is:

1. A one-piece, unitary rocket engine having a combustion chamber, a throat, and an exhaust bell integrally formed from a composite material and that together form an engine body, wherein:
the engine body comprises spaced apart inner and outer skins, with a plurality of spaced apart longitudinally extending ribs between the skins dividing the space between the skins into flow channels for circulation of a coolant; and
a toroidally shaped oxidizer ring is integrally formed with and as a continuation of the outer skin at a lower end of the exhaust bell.

2. A rocket engine as claimed in claim 1, wherein:
the inner and outer skins and oxidizer ring comprise a carbon fiber fabric material.

3. A rocket engine as claimed in claim 2, wherein:
a reinforcing and insulating layer of graphite material is coated on the inner surface of the inner skin.

4. A rocket engine as claimed in claim 3, wherein:
a reinforcing layer of Kevlar/carbon fiber material is applied to the outer surface of the outer skin.

5. A rocket engine as claimed in claim 4, wherein:
the ribs comprise a braided ceramic material.

6. A rocket engine as claimed in claim 2, wherein:
the exhaust bell has an exit end, and the oxidizer ring is formed at the exit end in encircling relationship thereto, said oxidizer ring being in fluid flow communication with the flow channels between the skins;
at least one oxidizer tube for connection between a supply of oxidizer and the oxidizer ring extends longitudinally of the engine in spaced relationship thereto, said at least one oxidizer tube being tangentially connected at a lower end thereof to the oxidizer ring for supply of oxidizer through the ring and into the flow channels, said flow channels being in fluid flow communication with the combustion chamber so that oxidizer flows through said at least one oxidizer tube, through said oxidizer ring, and through said flow channels, whereby the rocket engine is regeneratively cooled; and
said at least one oxidizer tube extends in spanning relationship to the throat and is supported at an upper end thereof by a mounting bracket bonded to the outside of the combustion chamber, whereby the at least one oxidizer tube serves not only to supply oxidizer to the engine but also reinforces the engine.

7. A rocket engine as claimed in claim 6, wherein:
said at least one oxidizer tube is made of a carbon fiber fabric material.

8. A rocket engine as claimed in claim 7, wherein:
the upper and lower ends of said at least one oxidizer tube are molded to the mounting brackets and to the oxidizer ring, respectively, by overlapping layers of carbon fiber fabric material bonded with a resin.

9. A rocket engine as claimed in claim 8, wherein:
a reinforcing layer of Kevlar/carbon fiber material is applied to the outer surface of said at least one oxidizer tube and the outer skin, including the oxidizer ring.

10. A rocket engine as claimed in claim 9, wherein:
the ribs comprise a braided ceramic material.

11. A rocket engine as claimed in claim 6, wherein:
there are a plurality of oxidizer tubes connected with said oxidizer ring at spaced locations around said oxidizer ring for more effective distribution of oxidizer into the flow channels.

12. A rocket engine as claimed in claim 11, wherein:
the mounting bracket is made of a carbon fiber fabric material bonded with a resin.

13. A method of forming a regeneratively cooled rocket engine having an engine body comprising a combustion chamber, a throat, and an exhaust bell, wherein the engine body has an inner skin and an outer skin defining a space therebetween, a plurality of spaced apart ribs extending between and bonded to the inner and outer skins, dividing the space between the skins into a plurality of flow channels extending longitudinally of the engine, an oxidizer ring encircling a lower end of the exhaust bell and in fluid communication with the flow channels, and at least one oxidizer tube extending longitudinally of the engine and connected at its upper end to a support bracket on the combustion chamber and at its lower end to the oxidizer ring, comprising the steps of:
applying to a mold one or more layers of carbon fiber fabric material bonded with a resin and curing the resin to form said inner skin as one piece;
removing said inner skin from the mold;
bonding a plurality of said ribs longitudinally on an outer surface of said inner skin;
placing an annular inflatable mold around a lower end of said inner skin;
applying one or more layers of carbon fiber fabric material around said inner skin and over said ribs and over said inflatable mold;
curing said outer skin; and
removing said inflatable mold to form said oxidizer ring as an integral part of said engine body.

14. A method of forming a rocket engine as claimed in claim 13, including the steps of:
applying to a mold one or more layers of carbon fiber fabric material bonded with a resin and curing the resin to form said at least one oxidizer tube; and
removing said at least one oxidizer tube from the mold and bonding it to said oxidizer ring and to said support bracket.

15. A method of forming a rocket engine as claimed in claim 14, wherein the mold comprises a firm but yieldable tubular body with a rigid spine extending therethrough, and including the steps of:
removing the rigid spine from the tubular body; and
removing the tubular body from the molded oxidizer tube.

16. A method of forming a tubular structure from a carbon fiber fabric material bonded with a resin, comprising the steps of:
providing a mold having a firm but yieldable tubular body with a rigid spine extending therethrough;
applying one or more layers of carbon fiber fabric material and a resinous bonding agent to the mold;
curing the bonding agent;
removing the rigid spine from the tubular body; and
removing the tubular body from the molded tubular structure.

17. A method as claimed in claim 16, wherein:
the mold has generally an L-shape and the rigid spine holds the yieldable tubular body in said L-shape, said spine being in two parts, and removing each part through a respective opposite end of the yieldable tubular body.
